(19) United States
(12) Patent Application Publication
(10) Pub. No.: US 2010/0050835 A1
(43) Pub. Date: Mar. 4, 2010

(54) METHOD FOR CUTTING A LOAF-SHAPED FOOD AND CUTTING MACHINE

(76) Inventor: Uwe Reifenhåuser, Flammersfeld (DE)

Correspondence Address: URSULA B. DAY, ESQ., 708 Third Avenue, SUITE 1501, NEW YORK, NY, 10017, US

(21) Appl. No.: 12/395,809

(22) Filed: Mar. 2, 2009

(30) Foreign Application Priority Data
Feb. 29, 2008 (DE) 10 2008 011 979.2

(51) Int. Cl. B26D 1/00; B26D 7/01

(52) U.S. Cl. 83/13; 83/167

(57) ABSTRACT

In a method for cutting a string-shaped food product which is fed towards a cutting device by means of a feeding device into slices, strips or cubes, the product string is fixed during the feed motion by means of a vacuum gripper, which is fed forward together with the product string; a vacuum, for acting on a fixing area at the surface of the product string in a suction area of the contact element, is generated within an interior of the contact element of the vacuum gripper; at least two rotating cutting edges of the contact element are provided and which enclose the suction area and cut into the product string in order to improve the quality of the sealing of the suction area

### CROSS-REFERENCES TO RELATED APPLICATIONS

This application claims the priority of German Patent Application Serial No. DE 10 2008 011 979.2, filed Feb. 29, 2008 pursuant to 35 U.S.C. 119(a)-(d), the subject matter of which is incorporated herein by reference.

### BACKGROUND OF THE INVENTION

The invention relates to a method for cutting a string-shaped food product, and in particular, to a method where the product string of the food product is fed towards a cutting device cutting the food product into slices, strips or cubes.

The invention also relates to a method wherein the product string is fixed during the feed motion by means of a vacuum gripper, which is fed forward together with the product string and wherein a vacuum, which acts on a fixing area of the surface of the product string in a suction area of the contact element, is generated within the interior of the contact element of the vacuum gripper, wherein at least one cutting edge of the contact element, which rotates and which encloses the suction area, cuts into the product string, thus attaining a sealing of the suction area.

The invention furthermore relates to a cutting machine for cutting a string-shaped food product, by means of which a product string of the food product can be cut into slices, strips or cubes including a feeding device, by means of which the product string can be fed towards the cutting device during the cutting process, wherein the feeding device encompasses a vacuum gripper, by means of which the product string can be fixed during the feed motion and which can be fed towards the cutting device together with the product string, wherein a vacuum, which acts on a fixing area of the surface of the product string in a suction area of the contact element, is generated within an interior of the contact element of the vacuum gripper, wherein the contact element encompasses at least one cutting edge, which rotates and which encloses the suction area and which can be pushed into the product string, thus sealing the suction area.

Methods for cutting string-shaped foods and cutting machine for cutting the product string of a food product into slices, strips or cubes are generally known. As compared to the use of gripper hooks, the fixing of the product string by means of a vacuum gripper provides the advantage that the product string itself remains undamaged because the surface thereof is not permanently changed by the contact element of the vacuum gripper. With the known methods and cutting machines, the vacuum generation takes place by means of so-called vacuum pumps. The vacuum is transferred via a line from the vacuum pump to the interior of the contact element. The contact element itself typically consists of a type of rubber sleeve, which, due to its elastic characteristics, is to compensate for possible unevenness and irregularities of the surface of the product string so as to keep air from penetrating into suction area of the rubber sleeve after being pressurized by a vacuum. The used vacuum pumps typically operate continuously during the cutting operation of the known machines so as to prevent turn-on and turn-off processes between the slicing of succeeding product strings on the one hand and so as compensate for possible leakiness in the area of the contact element on the other hand, whereby a flow of ambient air penetrates into the interior of the contact element, and to permanently maintain the vacuum to be sufficiently large.

Depending on the character and consistency of the surface of the product string in the fixing area thereof, as well as on the state of the rubber sleeve in the contact area, a loss of the vacuum is to be expected to a more or less frequent degree or to a more or less high degree, respectively. In response to a continuation of the feed process, the holding power, which is then lost, causes the product string to be able to shift laterally, thus likewise resulting in undesired displacements in the area of the cutting member of the cutting device, which lead to irregularly formed slices, strips or cubes. This is extremely undesired in view of the steadily increasing demands with respect to geometry accuracy in response to the cutting process.

To counter the afore-mentioned problem, it is known to equip the contact element of the vacuum gripper with a cutting edge, which cuts into the product string so that a sealing of the suction area is attained. A generic cutting machine, for example, is known from DE 100 24 913 A1, which describes a feeding device which includes at least one “suction cup”, defining a vacuum chamber, which is open towards the product string. The suction cup encompasses a cutting edge-shaped edge, which is to ensure a very tight connection of the suction cup with the product loaf.

The cutting machine described in U.S. Pat. No. 3,880,295 A also has a suction head comprising six suction areas arranged next to one another in linear direction, which have cutting edges for the purpose of carving into the front face of a cutting product, which is to be held. Each individual suction area is thereby formed by means of an annular space between an inner cutting edge and an outer cutting edge, which runs in concentric direction thereto. No suction area is located within the inner cutting edge. The circular ring-shaped suction area of U.S. Pat. No. 3,880,295 A is thus sealed in each case towards the outside as well as towards the inside by means of a cutting edge.

Finally, DE 10 2005 010 184 A1 discloses, among other things, a dome-shaped suction area comprising a rotating cutting ring, wherein a plurality of small ducts are located in the interior of the cutting ring, through which the vacuum is built up within the cutting ring.

As a matter of principle, the cutting of the cutting rings into the product string provides for a good sealing of the suction area. However, it can occur in particular in response to string-shaped food products, which encompass irregularities for example in the form of cavities (cheese) or hard pieces (bones), that the cutting rings do not engage with the product string in the area of an irregularity so that a tightly closed suction area is not created and a vacuum can thus not be built up.

It would therefore be desirable and advantageous to provide an improved method of cutting a string-shaped food product and to provided a corresponding cutting machine to obviate prior art shortcomings and to enhance reliability as to permanently maintaining the vacuum generated in the vacuum gripper is increased so as to avoid interferences in the operating procedure and negative effects on the cutting quality, respectively.

### SUMMARY OF THE INVENTION

According to one aspect of the present invention, a method for cutting a string-shaped food product, includes the steps of feeding a product string of the food product towards a cutting device by means of a feeding device for cutting the food product into slices, strips or cubes, the product string including at least one fixing area; fixing the product string during the feed motion by means of a vacuum gripper, which is moving forward together with the product string; generating a vacuum within an interior of a contact element of the vacuum gripper which is acting on the at least one fixing area of the surface of the product string within a suction area of the contact element; wherein a cutting edge of the contact element, which rotates and which encloses the suction area, is cutting into the product string, thereby sealing the suction area; cutting with at least one further cutting edge of the contact element, which rotates and encloses the cutting edge into the product string, thereby attaining a further sealing of the suction area.

According to another aspect of the invention, a cutting machine for cutting a string-shaped food product includes a cutting device for cutting a product string of the food product into slices, strips or cubes, the string-shaped food product having a fixing area on a surface of the food product; and a feeding device for feeding the food product towards the cutting device during the cutting process, wherein the feeding device includes a vacuum gripper for fixing the product string during the feed motion of the vacuum gripper towards the cutting device together with the product string, wherein a vacuum generated within an interior of a contact element of the vacuum gripper, acts on the fixing area of the surface of the product string in at least one suction area of the contact element, wherein the contact element includes a first rotating cutting edge which encloses a suction area for pressing into the product string thereby sealing the suction area, and at least a second rotating cutting edge which encloses the cutting edge for pressing into the product string to thereby seal the suction area once again.

The present invention resolves prior art problems by providing at least one further rotating cutting edge of the contact element, which encloses the first cutting edge, cuts into the product string, thus attaining a further sealing.

According to a further aspect of the present invention it was realized that a superficial contact between contact element and product string is not sufficient for a reliable sealing of the suction area. Therefore, according to the present invention a compromise between vacuum grippers comprising rubber sleeves and gripper hooks comprising teeth is followed, because, according to the invention, the vacuum impingement is combined with a cutting into the surface of the product string. Due to the fact that the penetration of the cutting edges of the contact element can be limited to a very small depth and only serves for the improved sealing, the integrity of the product string also remains for the most part in the contact area. The remaining piece of the product string, which remains after the actual slicing process has ended and into which the cutting edges of the contact element had cut, can thus also be used in a sensible manner quasi without a loss of quality as compared to the use of vacuum grippers comprising rubber sleeves. With the method according to the invention, the penetration depth of the cutting edges can be limited to a range of between approx. 0.1 mm and 5 mm, typically approx. 2 mm to 3 mm so that in almost all of the cases barely visible damages to the product string surface are present. This applies in particular when the cutting edges are preferably embodied so as to be very sharp and thus also require only a low penetration power.

The arrangement according to the invention of a further cutting edge, which encloses the first cutting edge, hereby performs a safety function, which becomes apparent in particular when the first cutting edge is faulty due to irregularities in the product string cross section due to the sealing of the suction area so that no holding power or only an insufficient holding power can be generated. That is to say, the further cutting edge then forms a larger suction area, which encompasses the permeable suction area of the first cutting edge, in which a vacuum can be maintained without any problem. If the sealing is already all right in the area of the first cutting edge, it is not important whether the further cutting edge does not completely seal in parts due to possible irregularities in the product string cross section, because the suction area formed by the first cutting edge is already tight. Even though it cannot be ruled out that the product string end is so irregular that the first as well as the further cutting edge engage into the product string in a non-sealing manner, the probability for this should be extremely low.

In any case, it is possible with the method according to the invention to considerably increase the quality of the sealing so that the vacuum losses during the slicing process are typically so small that once a vacuum has been generated, it must no longer be renewed, but remains until the slicing process has ended.

According to an advantageous development of the method, provision is made for a vacuum to be generated in each case in an inner suction area, which is defined by a cross section surrounding an inner cutting edge as well as in an outer suction area, which is defined by the cross section between an outer cutting edge and the inner cutting edge. Consequently, two directly adjacent suction areas are created, which are separated from one another by the inner cutting edge and which act independent on one another, wherein the afore-described safety function is improved in that the entire suction area (addition of the two partial suction areas), which is generated by the possible “malfunction” of the inner cutting edge, is impinged with a sufficient vacuum.

To create the counteracting force to the contact force of the vacuum gripper, which is required in the contacting phase, it is proposed to support the product string during the cutting of the cutting edge of the contact element at the end thereof, which is located opposite to the vacuum gripper, by means of a cutting element of the cutting device and/or by means of a hold-down device, which engages with a jacket surface of the product string.

Due to the cutting of the cutting edge into the product string, a certain friction permanently prevails between the cutting edge and the product string. To be able to remove the remaining rest of the product string after the slicing process ended, a pressure, which acts on the surface area of a remaining piece remaining from the product string, can be generated in the interior of the vacuum gripper after the cutting process has ended, whereby the remaining piece is ejected. The suction area thus briefly turns into a vacuum area, by means of which an ejection power is generated, which overcomes the friction.

In terms of the device, the underlying object, based on a cutting machine of the afore-described type, is solved in that at least one further rotating cutting edge of the contact element, which encloses the cutting edge can be pressed into the product string, thus sealing the suction area once more.

Generally, the cutting edge can encompass arbitrary shapes, which form a closed curve. Typically, the cutting edge will be circular, elliptical, oval, rectangular, triangular or trapezoidal.

So as to effect a defined end in response to the penetration of the cutting edge into the product string, a step can join the cutting edge—viewed in the direction facing away from the cutting edge thereof—preferably outward in radial direction according to an advantageous development of the invention. This step acts as a stop and would oppose a highly increased power to the penetration of the cutting edge, which can be used as evidence for example for the end of the power-driven cutting.

The sealing effect of the vacuum gripper can be improved further when both of the cutting edges are in each case defined in their own suction area and wherein the outer cutting edge projects further in the direction of the cutting device as compared to the inner cutting edge, which has an advantageous effect on the cutting safety of the outer cutting edge in response to a convex form of the end of the product string.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a side elevational view of a vacuum gripper according to the present invention;

FIG. 2 is a perspective view of a vacuum gripper obliquely from the front,

FIG. 3 is a perspective view of the vacuum gripper obliquely from the rear,

FIG. 4 is a rear elevational view of the vacuum gripper according to FIGS. 1 to 3,

FIG. 5a is a longitudinal section along line V-V shown in FIG. 4 through the vacuum gripper in a start position,

FIG. 5b is a longitudinal section along V-V shown in FIG. 4 through the vacuum gripper in a vacuum position,

FIG. 6 is a perspective view of a gripper device comprising a base frame and three vacuum grippers supported therein according to FIGS. 1 to 5,

FIG. 7 is a side view of the griper device according to FIG. 6, and

FIG. 8 is a top view onto the gripper device according to FIG. 6.

### DETAILED DESCRIPTION OF PREFERRED EMBODIMENTS

Throughout all the Figures, same or corresponding elements are generally indicated by same reference numerals.

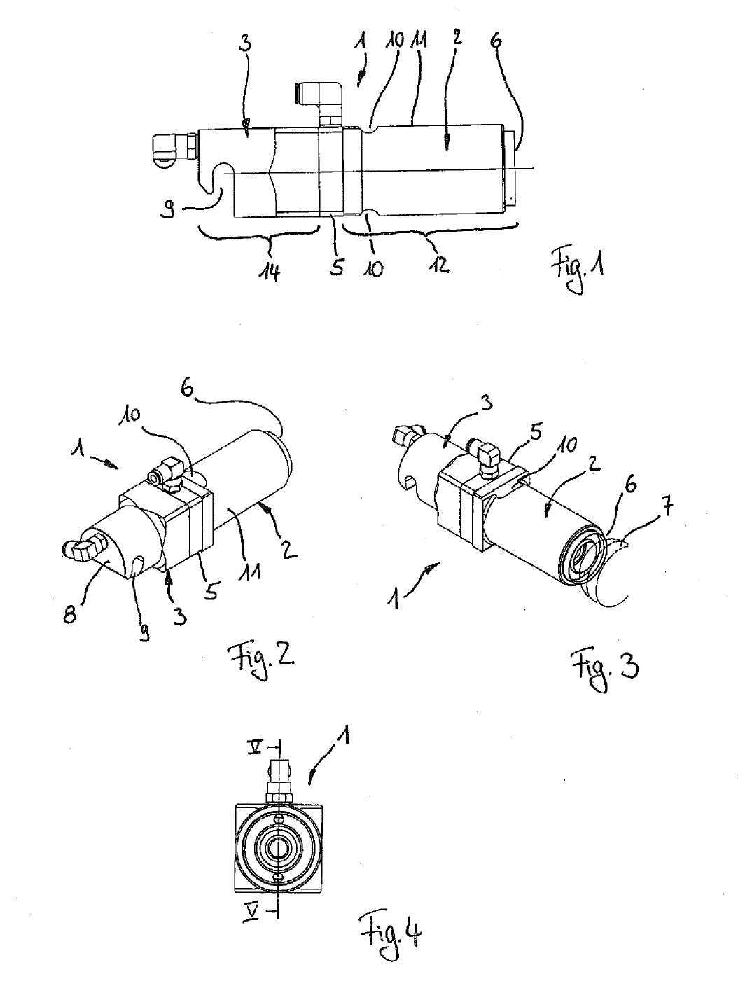

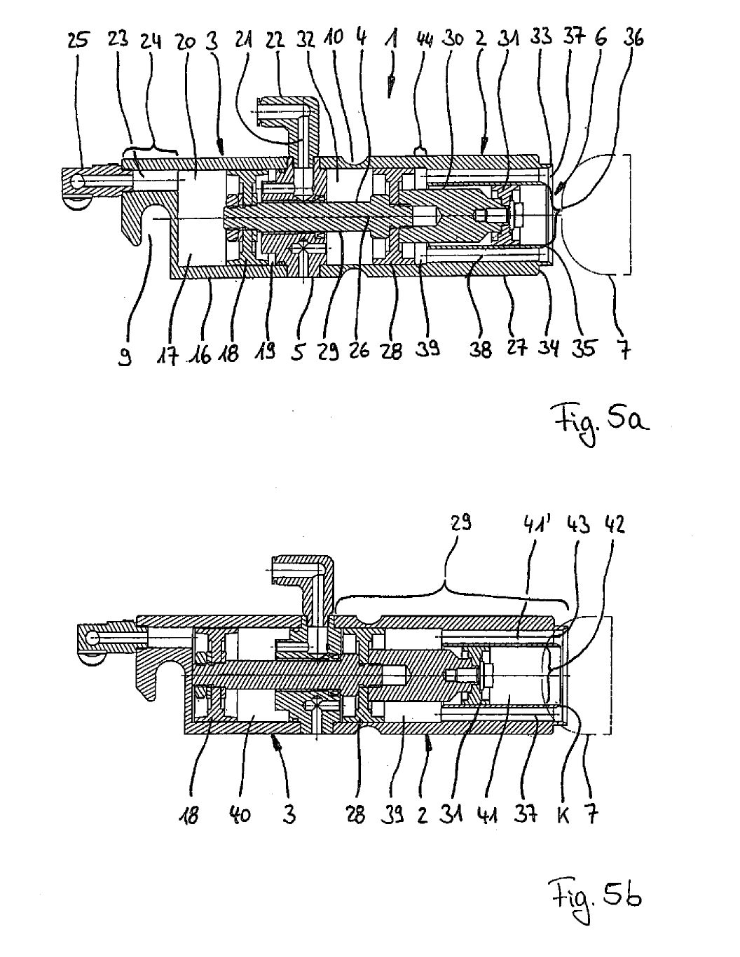

Turning now to the drawing, and in particular to FIG. 1, there is shown a vacuum gripper 1 shown in FIGS. 1 to 5b consists of two piston-cylinder units 2 and 3, which are arranged behind one another in coaxial direction, which are coupled to one another via a common piston rod 4 and which are separated from one another by means of a separating wall 5, in which the piston rod 4 is supported in a sliding and sealed manner.

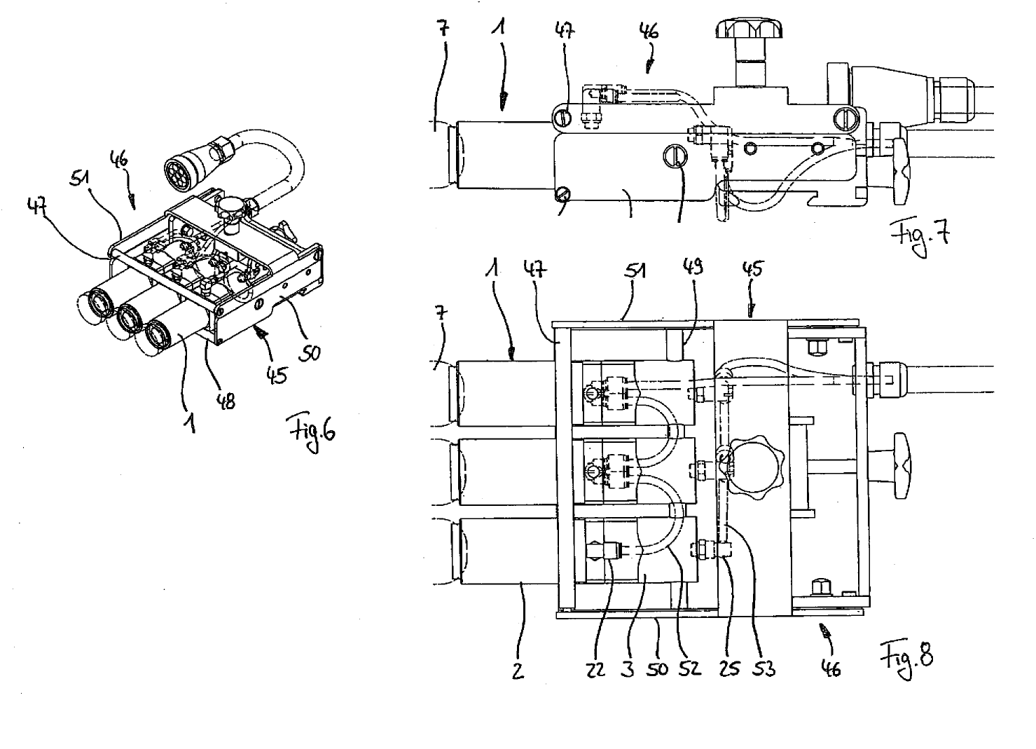

The vacuum gripper 1 has a front side 6, to which a product string 7 illustrated in a dashed manner in FIG. 1, for example in the form of a pork sausage, is fixed by means of a vacuum in a manner, which will be described in more detail hereinbelow. Opposite thereto, the vacuum gripper 1 has a rear side 8, to which it can be fastened by means of a slot-shaped recess 9 on a base frame of a gripper device, which is illustrated in FIGS. 6 to 8 and which will be described in more detail hereinbelow. Two chamfer-shaped recesses 10 in a jacket surface 11 of the vacuum gripper 1 furthermore serve the purpose of fastening.

Following the separating wall 5, the vacuum gripper 1 has a front part 12, which is formed by the piston-cylinder unit 2, which serves the purpose of generating the vacuum for fixing the product string 7. The rear part 14 located opposite thereto is substantially formed by the further piston-cylinder unit 3, which serves the purpose of driving a piston of the piston-cylinder unit 2, which is located in the front part 12.

It can be seen from FIG. 5a that the piston-cylinder unit 3, which, as already mentioned, serves as drive for the vacuum generation, consists of a cylinder tube 16 and a piston 18, which is supported in the interior 17 thereof so as to be displaceable and sealed and which divides the interior 17 into a first working chamber 19 facing the separating wall 5 and a second working chamber 20 located on the other side of the piston 18. The working chamber 19 can be pressurized via a duct 21, which, in a plurality of sections, is initially located in a connecting piece 22 inserted into the separating wall 5 and then in the separating wall 5 itself. In the separating wall 5 as well as in the connecting piece 22, the duct has two sections, which run at a right angle to one another, thus resulting in a U-shape of the duct 21 as a whole. The second working chamber 17 is arranged above a duct 23 in an extension 24 of the rear part 14. It also runs in a rear connecting piece 25.

The piston-cylinder unit 2, which serves the purpose of generating a vacuum for fixing the product string 7 is located on the opposite side of the separating wall 5 in coaxial direction to the piston-cylinder unit 3—relating to a common axis 26. The piston-cylinder unit 2 also consists substantially of a cylinder tube 27, in which a piston 28 is supported in a sliding and sealed manner. The piston 28 of the piston-cylinder unit 2 and the piston 18 of the piston-cylinder unit 3 have the same diameter and, due to the coupling by means of the piston rod 4, they have the same stroke.

A further piston rod 30, which leads to a further piston 31 connected thereto, is located on the side of the piston 28 located opposite to the piston rod 4. The piston 31 is located in a section of the cylinder tube 27, in which it has a diameter, which is reduced as compared to the piston 28 and as compared to the working chamber 32, which corresponds therewith. The unit formed from the pistons 28 and 31 (as well as from the piston rod 30) is thus a stepped piston, which is supported in a correspondingly stepped hole of the cylinder tube 27 so as to be displaceable in axial direction.

A circularly rotating outer cutting edge 33, the wall thickness of which is considerably reduced as compared to the remaining wall thickness of the cylinder tube 27, is embodied on the front side 6 of the vacuum gripper 1, wherein the transition from the cutting edge 33 into the remaining wall of the cylinder tube 27 takes place in the form of a radial step 34. The front side 6 of the vacuum gripper 1 is furthermore provided with an inner cutting edge 35, which is also embodied so as to be circular and which runs in concentric direction to the outer cutting edge 33. As compared to the leading edge of the outer cutting edge 33, the leading edge of the inner cutting edge 35 is set back slightly. The inner diameter in the area of the inner cutting edge 35 corresponds to the diameter of the front piston 31 with the smaller diameter. The two cutting edges 33 and 35 together with the cylinder tube 27 form a contact element 29 of the vacuum gripper 1.

The circular cross section, which is defined by the inner cutting edge 35, defines an inner suction area 36. The circular ring area, which is located between the inner suction area 36 and the outer cutting edge 33, defines an outer suction area 37. The outer suction area 37 is connected to a right working chamber 39, which is defined by the piston 28, via two holes, which are arranged so as to be offset to one another by 180°.

Based on the position shown in FIG. 5a, in which both cutting edges 33 and 35 are located at a distance to the end of the product string 7, the vacuum gripper 1 is moved up to the product string 7, which supports itself with its opposite front end on a non-illustrated cutting device, e.g. in the form of a cut-off knife, which is driven in a rotatory manner. The approximation of the vacuum gripper takes place to such an extent and with sufficiently large power that—as is shown in FIG. 5b—both cutting edges 33 and 35 penetrate into the product string 7. Due to the rounded shape of the end of the product string 7, the inner cutting edge 35 penetrates deeper than the outer cutting edge 33. The penetration motion is then made to be increasingly difficult and is also ended when the product string 7 supports itself with its front surface in the area of the radial step 34 of the vacuum gripper, which, however, is not yet the case in the position shown in FIG. 5b.

After the two cutting edges 33 and 35 have penetrated into the material of the product string 7 and have thus effected a sealing of the two suction areas 36 and 37, the right working chamber 40 of the piston-cylinder unit 3 is pressurized, whereby the two pistons 28 and 31 are also displaced to the left into the position as illustrated in FIG. 5b. The working chamber 39, which is located to the right of the piston 28, as well as the interior 41, which corresponds to the inner suction area 36, are thus highly increased in the section of the cylinder tube 27, the diameter of which is reduced so that a vacuum is generated in both of the suction areas 36, 37, which securely fixes the product string 7 to the vacuum gripper 1. Due to the sealing of the suction areas 36 and 37, which is highly effective due to the cutting edges 33 and 35, it is sufficient to move the pistons 28 and 31 back one time, that is, a one-time generation of a vacuum is sufficient to permanently ensure a sufficiently large holding power. Due to the fact that the inner suction area 36 is completely surrounded by the outer suction area 37, that is, the pressure difference between both areas is small or zero, in the ideal case, there is almost no danger of losing the vacuum in particular in view of the inner suction area 36. Even if air should penetrate into the outer suction area 37 past the outer cutting edge 33, a sufficiently large vacuum will still remain in response to a sufficiently good sealing by means of the inner cutting edge 35 in the inner suction area 36.

The inner suction area 36 acts on an inner fixing area 42 on the surface of the product string 7 and the outer suction area 37 accordingly acts on an outer fixing area 43 on the surface of the product string 7.

The vacuums occurring in the suction areas 36 and 37 after a stroke of the piston 18, which is responsible for activation, can be influenced by the selection of the diameters of the pistons 28 and 31, of the diameter of the piston rod 4 as well as of the diameters and the number of the holes 38. It is sensible thereby to choose the vacuum generated in the inner suction area 36 to be greater than in the outer suction area 37, because the inner suction area 36 is arranged so as to be “protected” by the outer suction area 37.

After the product string 7 has been fixed by activating the vacuum gripper, the product string 7 can be fed forward towards the cutting device together with the vacuum gripper 1, while successive slices are cut at the leading end of the product string 7. Shortly before the outer cutting edge 33 reaches into the sphere of the cut-off knife of the cutting device, the feed motion is interrupted. A reliable ejection of the remaining piece of the product string 7, which then still adheres to the vacuum gripper 1, is attained in that the pistons 28 and 31 are not only moved back into the starting position shown in FIG. 5a by means of the pressurization of the working chamber 20 above the connecting pieces 25, but is furthermore moved towards the right by an additional stroke 44 (see FIG. 5a) until the piston 28 strikes the step in the cylinder tube 27, which is a result of the difference in diameter. In the suction areas 36 and 37, the pressure is hereby not only returned to the base level, that is, zero, but a certain vacuum by means of which the remaining piece of the product string 7 is actively conveyed out, is generated in both suction areas 36 and 37, wherein the friction appearing in the area of the cutting edges 33 and 35 must be overcome. Finally, the pistons 18, 28 and 31 are returned back into the starting position shown in FIG. 5a without the front side 6 of the vacuum gripper coming into contact with a product string 7, which is to be sliced next, so that atmospheric pressure continues to prevail in the suction areas 36 and 37.

It results from FIG. 6 that three vacuum grippers 1, as they are described in FIGS. 1 to 5b, are arranged parallel next to one another in a base frame 45 of a gripper device 46. Cross bars 47 to 49, which together with side parts 50 and 51 form the base frame 45, fix the vacuum grippers 1 in the base frame 45 via the recesses 9 and 10 shown in FIGS. 1 to 3.

The connecting pieces 25 and 22 of the respectively rear piston-cylinder unit 3 for activating the front piston-cylinder units 2 for generating the vacuum are connected in parallel via compressed air lines 52 and 53 so that the vacuum for fixing is always generated or eliminated simultaneously for three product strings 7 located next to one another and the remaining pieces are ejected.

The base frame 45 of the gripper device 46 is known and serves in an identical embodiment for accommodating classical, purely mechanical grippers, where a gripper hook penetrates into the rear end of the product string 7 with its gripper teeth due to a pneumatic activation, wherein the gripper teeth are likewise pulled out of the remaining piece due to a pneumatic activation after the cutting process has ended. The available base frame 45 and the compressed air connections, which are already present there, can be used for vacuum gripper 1 as well as for mechanical grippers comprising gripper teeth, which are not illustrated in the figures.

While the invention has been illustrated and described as embodied in a string-shaped food cutting method and apparatus, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and their equivalents:

1. A method for cutting a string-shaped food product, comprising the steps of feeding a product string of the food product towards a cutting device by means of a feeding device for cutting the food product into slices, strips or cubes, the product string including at least one fixing area; fixing the product string during the feed motion by means of a vacuum gripper, which is moving forward together with the product string; generating a vacuum within an interior of a contact element of the vacuum gripper which is acting on the at least one fixing area of the surface of the product string within a suction area of the contact element; wherein a cutting edge of the contact element, which rotates and which encloses the suction area, is cutting into the product string, thereby sealing the suction area; cutting with at least one further cutting edge of the contact element, which rotates and encloses the cutting edge into the product string, thereby attaining a further sealing of the suction area.

2. The method according to claim 1, wherein a vacuum is generated in an inner suction area and in an outer suction area, the inner suction area being defined by a cross section surrounding an inner cutting edge in the outer suction area, said outer suction area being defined by a cross section between an outer cutting edge and the inner cutting edge.

3. The method according to claim 2, wherein the product string, during the cutting by the cutting edge of the contact element located opposite the vacuum gripper, is supported by means of at least one of: a cutting element of the cutting device and by a hold-down device, which engages with a jacket surface of the product string.

4. The method according to one of claims 1, wherein a pressure is being generated in the interior of the contact element which acts on the surface area of a remaining piece of the product string after the cutting process has ended, whereby the remaining piece is ejected.

5. A cutting machine for cutting a string-shaped food product comprising a cutting device for cutting a product string of the food product into slices, strips or cubes, the string-shaped food product having a fixing area on a surface of the food product; and a feeding device for feeding the food product towards the cutting device during the cutting process, wherein the feeding device includes a vacuum gripper for fixing the product string during the feed motion of the vacuum gripper towards the cutting device together with the product string, wherein a vacuum generated within an interior of a contact element of the vacuum gripper, acts on the fixing area of the surface of the product string in at least one suction area of the contact element, wherein the contact element includes a first rotating cutting edge which encloses a suction area for pressing into the product string thereby sealing the suction area, and at least a second rotating cutting edge which encloses the cutting edge for pressing into the product string to thereby seal the suction area once again.

6. The cutting machine according to claim 5, wherein the cutting edge is in a shape selected from the group of circular, elliptical, oval, rectangular, triangular or trapezoidal.

7. The cutting machine according to claim 5, wherein a step oriented outward in radial direction, joins the first cutting edge in a direction facing away from the cutting edge.

8. The cutting machine according to one of claims 5, wherein each of the cutting edges define a suction area, and wherein the outer cutting edge projects further in the direction towards the cutting device as compared to the inner cutting edge.
